(19) United States
(12) Patent Application Publication
(10) Pub. No.: US 2007/0145613 A1
(43) Pub. Date: Jun. 28, 2007

(54) CONCAVE/CONVEX PATTERN FORMING METHOD AND INFORMATION RECORDING MEDIUM MANUFACTURING METHOD

(75) Inventors: Mikiharu HIBI, Tokyo (JP); Minoru FUJITA, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 11/610,731

(22) Filed: Dec. 14, 2006

(30) Foreign Application Priority Data
Dec. 22, 2005 (JP) 2005-369331

(51) Int. Cl. B29D 17/00

(52) U.S. Cl. 264/1.33

(57) ABSTRACT

A concave/convex pattern forming method which is capable of forming a concave/convex pattern on a substrate with high accuracy without causing deformation or faulty transfer of the concave/convex pattern. A concave/convex pattern is formed on an preform by pressing a stamper having a stamper-side concave/convex pattern formed thereon against a resin layer on the preform, thereby transferring the stamper-side concave/convex pattern to the resin layer. The resin layer is formed by coating the preform with a mixed resin material which is prepared by mixing a first resin material having a glass transition is temperature lower than a temperature of the resin layer during pressing of the stamper against the resin layer, and a second resin material having a glass transition temperature higher than the temperature of the resin layer during the pressing of the stamper against the resin layer.

### BACKGROUND OF THE INVENTION

1. Field of the Invention

The present invention relates to a method of forming a concave/convex pattern on a substrate by pressing a stamper against a resin layer formed on the substrate, and a method of manufacturing an information recording medium by using the concave/convex pattern formed by the concave/convex pattern forming method.

2. Description of the Related Art

As a concave/convex pattern forming method of this kind, there has been disclosed an imprinting method in U.S. Pat. No. 6,814,898, which forms a concave/convex pattern on a substrate (glass substrate) by pressing a stamper (metal-based stamper) having the concave/convex pattern formed thereon against a resin layer (resist layer) formed on the substrate to thereby transfer the concave/convex pattern on the stamper to the resin layer. In the concave/convex pattern forming method, first, as shown in FIG. 1A of the specification of the patent, the resin layer is formed on the substrate on which the concave/convex pattern should be formed. Then, as shown in FIG. 1B of the specification, the stamper is pressed against the resin layer on the substrate, to thereby transfer the concave/convex pattern on the stamper to the resin layer. In doing this, in the concave/convex pattern forming method, the stamper is pressed against the resin layer under room temperature conditions without heating the laminate of the substrate and the resin layer, and the stamper. Subsequently, as shown in FIG. 1C of the specification, the stamper is removed from the resin layer, whereafter as shown in FIG. 1D of the specification, an etching process is performed on bottom surfaces of concave portions of the concave/convex pattern transferred to the resin layer, whereby the substrate is exposed from the bottom surfaces of the concave portions from which the resin layer has been removed. Thus, the concave portions of the concave/convex pattern are formed at portions of the resin layer into which convex portions of the stamper have been pushed, and convex portions of the concave/convex pattern are formed at portions of the resin layer into which the concave portions of the stamper have been pushed, whereby the concave/convex pattern is formed on the substrate (in the resin layer).

### SUMMARY OF THE INVENTION

From the study of the above described conventional concave/convex pattern forming method, the present inventors found the following problems. In the conventional concave/convex pattern forming method, the stamper is pressed against the resin layer without heating or cooling the laminate and the stamper. However, for example, when the concave/convex pattern is formed according to the concave/convex pattern forming method, on a resin layer which is formed using a resin material having a glass transition temperature lower than the temperature (room temperature) of the resin layer during pressing of the stamper against the resin layer, the convex portions of the stamper can be pushed into the resin layer smoothly when the stamper is pressed against the resin layer, but the concave/convex pattern transferred to the resin layer is gradually deformed with the lapse of time after the transfer of the concave/convex pattern is completed and the stamper is removed from the resin layer. Further, for example, when the concave/convex pattern is formed according to the concave/convex pattern forming method, on a resin layer which is formed using a resin material having a glass transition temperature higher than the temperature (room temperature) of the resin layer during pressing of the stamper against the resin layer, although it is possible to avoid large deformation of the concave/convex pattern after removal of the stamper, it is difficult to push the convex portions of the stamper into the resin layer, which makes it impossible to form concave portions having a sufficient depth (convex portions having a sufficient height) with respect to the resin layer (occurrence of faulty transfer). As described above, the conventional concave/convex pattern forming method suffers from the problem that it causes deformation of the concave/convex pattern formed on the substrate or faulty transfer of the concave/convex pattern to the resin layer.

The present invention has been made in view of these problems, and a main object of the present invention is to provide a concave/convex pattern forming method which is capable of forming a concave/convex pattern on a substrate with high accuracy without causing deformation or faulty transfer of the concave/convex pattern, and an information recording medium manufacturing method which is capable of forming a concave/convex pattern over the whole area of the substrate with high accuracy.

To attain the above object, there is provided a concave/convex pattern forming method comprising pressing a stamper having a stamper-side concave/convex pattern formed thereon against a resin layer on the substrate, thereby transferring the stamper-side concave/convex pattern to the resin layer to form a concave/convex pattern on the substrate, wherein the resin layer is formed by coating the substrate with a mixed resin material which is prepared by mixing a first resin material having a glass transition temperature lower than a temperature of the resin layer during pressing of the stamper against the resin layer, and a second resin material having a glass transition temperature higher than the temperature of the resin layer during the pressing of the stamper against the resin layer. It should be noted that the mixed resin material in the present invention includes not only the mixed resin material prepared by mixing only the first resin material and the second resin material but also various mixed resin materials containing additives and other resin materials in addition to the first and second resin materials.

According to the concave/convex pattern forming method of the present invention, the mixed resin material prepared by mixing the first resin material having a glass transition temperature lower than the temperature of the resin layer during pressing of the stamper against the resin layer, and the second resin material having a glass transition temperature higher than the temperature of the resin layer during the pressing of the stamper against the resin layer is applied to the substrate to thereby form the resin layer. This makes it possible to push the convex portions of the stamper-side concave/convex pattern deep enough into the resin layer smoothly when the stamper is pressed against the resin layer. Therefore, it is possible to form the concave/convex pattern on the substrate with high accuracy while preventing the occurrence of faulty transfer of the concave/convex pattern due to an insufficient pushing amount of the convex portions. Further, it is possible to prevent large deformation of the concave/convex pattern to maintain the concave/convex shape of the concave/convex pattern with high accuracy, after removal of the stamper from the resin layer.

Also, there is provided an information recording medium manufacturing method comprising using the concave/convex pattern formed on the substrate according to the concave/convex pattern forming method to manufacture an information recording medium.

According to the information recording medium manufacturing method of the present invention, by manufacturing the information recording medium using the concave/convex pattern formed on the substrate according to the concave/convex pattern forming method, it is possible to form the concave/convex pattern with high accuracy over the whole area of the substrate by subjecting the substrate to an etching process using e.g., the formed concave/convex pattern as a mask pattern, or a concave/convex pattern matching the formed concave/convex pattern in the concave-convex positional relationship as a mask pattern.

It should be noted that the present disclosure relates to the subject matter included in Japanese Patent Application No. 2005-369331 filed Dec. 22, 2005, and it is apparent that all the disclosures therein are incorporated herein by reference.

### BRIEF DESCRIPTION OF THE DRAWINGS

These and other objects and features of the present invention will be explained in more detail below with reference to the attached drawings, wherein:

FIG. 1 is a cross-sectional view of a magnetic disk;

FIG. 2 is a cross-sectional view of a stamper;

FIG. 3 is a cross-sectional view of a preform in a state in which a resin layer is formed on a recording layer;

FIG. 4 is a cross-sectional view showing a state where the stamper is pressed against the resin layer on the preform;

FIG. 5 is a cross-sectional view of the preform in a state in which the stamper is removed from the resin layer in the state as shown in FIG. 4;

FIG. 6 is a diagram useful in explaining easiness of pushing the stamper into each of resin layers of Examples 1 to 4 and Comparative Examples 1 and 2, and stability of the concave/convex shape of a concave/convex pattern transferred to each resin layer;

FIG. 7 is a diagram useful in explaining easiness of pushing the stamper into each of resin layers of Examples 1 and 5 to 12 and Comparative Examples 3 and 4, and stability of the concave/convex shape of a concave/convex pattern transferred to each resin layer;

FIG. 8 is a diagram useful in explaining easiness of pushing the stamper into each of resin layers of Examples 2 and 13 to 20 and Comparative Examples 4 and 5, and stability of the concave/convex shape of a concave/convex pattern transferred to each resin layer;

FIG. 9 shows a figure-substitute photograph of a surface of a resin layer, in which a concave/convex pattern (data track pattern) is formed with the occurrence of faulty transfer caused by an insufficient pushing amount of convex portions of the stamper;

FIG. 10 shows a figure-substitute photograph of a surface of a resin layer, in which a concave/convex pattern (data track pattern) is formed without the occurrence of faulty transfer;

FIG. 11 shows a figure-substitute photograph of a surface of a resin layer in a state in which a concave/convex pattern formed on the surface is largely deformed;

FIG. 12 shows a figure-substitute photograph of a surface of a resin layer in a state in which a concave/convex pattern formed on the surface is deformed to such a slight degree that will permit the concave/convex pattern to be used as a mask pattern;

FIG. 13 shows a figure-substitute photograph of a surface of a resin layer in a state in which a concave/convex pattern formed on the surface is deformed very slightly; and

FIG. 14 shows a figure-substitute photograph, of a surface of a resin layer in a state in which a concave/convex pattern formed on the surface is hardly deformed.

### DESCRIPTION OF THE PREFERRED EMBODIMENTS

Now, preferred embodiments of a concave/convex pattern forming method and an information recording medium manufacturing method according to the present invention will be described with reference to the accompanying drawings.

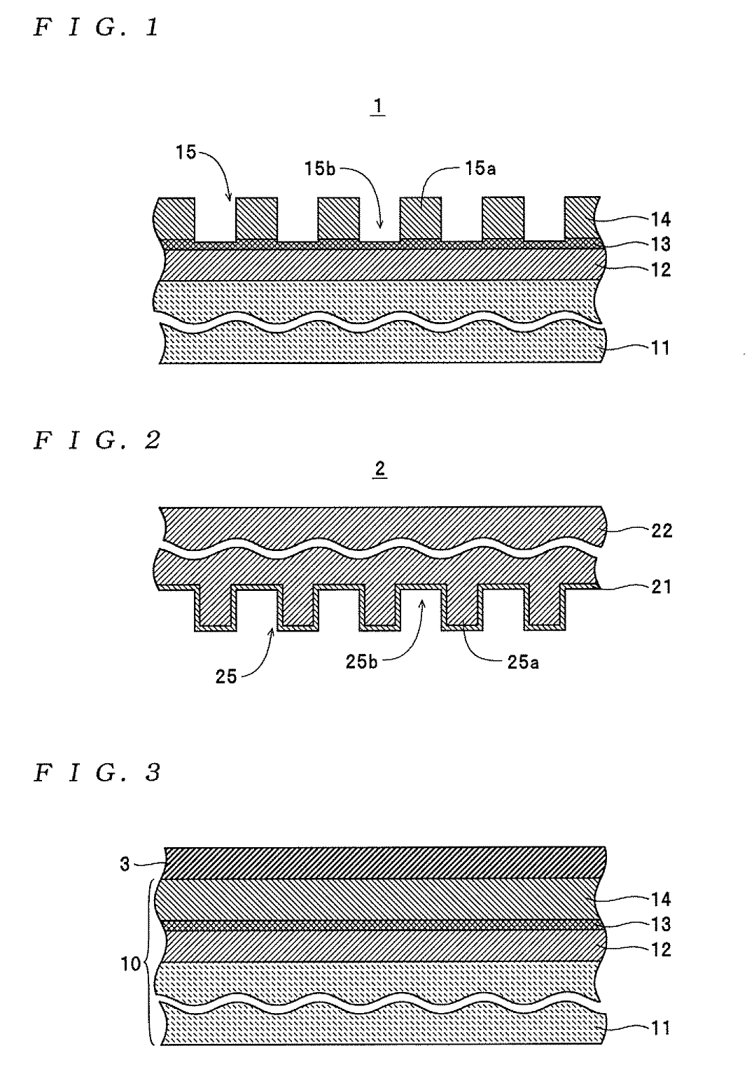

Referring first to FIG. 1, a magnetic disk 1 is a discrete track-type magnetic recording medium (patterned medium) which is capable of recording recording data e.g., by a perpendicular recording method. The magnetic disk 1 has a soft magnetic layer 12, an intermediate layer 13, and a recording layer (magnetic recording layer) 14 sequentially formed on a base plate 11 in the mentioned order. The magnetic disk 1 corresponds to an information recording medium in the present invention, and has one surface thereof (upper surface thereof as viewed in FIG. 1) formed with a concave/convex pattern 15, which is formed by plural convex portions 15a each having at least a protruding end thereof made of a magnetic material (recording layer 14) and plural concave portions 15b, and serves as a data track pattern or a servo pattern. On the other hand, as shown in FIG. 2, a stamper 2 is a master disk for forming a concave/convex pattern 35 (see FIG. 5) as a mask pattern on a preform 10 (substrate in the present invention; see FIG.3) during manufacturing of the magnetic disk 1, and is configured to have a generally circular plate shape. The stamper 2 has a shape of a thin plate formed by forming a nickel layer 22 on a nickel layer 21 by an electroforming process using the nickel layer 21 as an electrode. Further, the stamper 2 is formed with a concave/convex pattern 25 (an example of a “stamper-side concave/convex pattern” in the present invention) having plural convex portions 25a formed in association with the respective concave portions 15b of the concave/convex pattern 15 of the magnetic disk 1, and plural concave portions 25b formed in association with the respective convex portions 15a of the concave/convex pattern 15. Further, as shown in FIG. 3, the preform 10 has the soft magnetic layer 12, the intermediate layer 13, and the recording layer 14 sequentially formed on the base plate 11 in the mentioned order.

In manufacturing the above described magnetic disk 1, first, the concave/convex pattern 35 as a mask pattern is formed on the preform 10 according to the concave/convex pattern forming method of the present invention. In doing this, first, a mixed resin material is prepared by mixing a resin material which has a glass transition temperature lower than the temperature (e.g., 22° C.) of a resin layer 3 (see FIG. 3) (i.e., a resin material having a low elastic modulus and a high fluidity: “a first resin material” in the present invention) during an imprinting process described hereinafter, and a resin material which has a glass transition temperature higher than the temperature of the resin layer 3 (i.e., a resin material having a high elastic modulus and a low fluidity: “a second resin material” in the present invention) during the imprinting process. More specifically, for example, the mixed resin material is prepared by mixing an acrylic resin having a glass transition temperature of 13° C., a weight-average molecular weight of 5782, and an elastic modulus of 1.59 GPa (an example of the first resin material in the present invention), and an acrylic resin having a glass transition temperature of 34° C., a weight-average molecular weight of 5074, and an elastic modulus of 2.98 GPa (an example of the second resin material in the present invention) such that a volume ratio (mixing ratio) thereof becomes equal to 1:1.

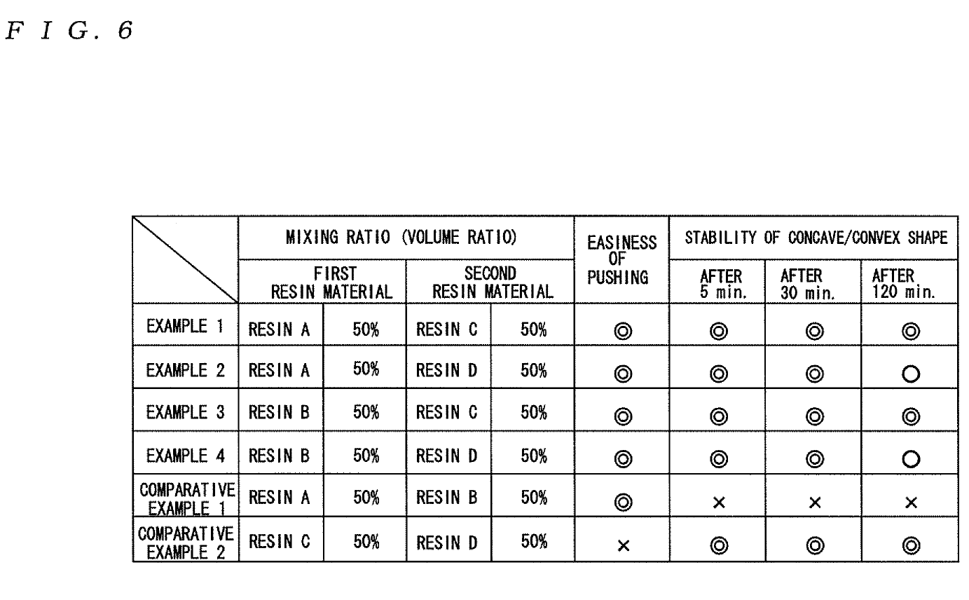

In this case, PGMEA (propylene glycol monomethyl ether) is used as a solvent for the above acrylic resins. Further, the acrylic resins are copolymers of acrylic acid ester and methacrylic acid ester, and have glass transition temperatures thereof adjusted by changing the composition ratio of molecules (in monomer unit), while having characteristics thereof made different by adding various additives thereto in addition to the above solvent. It should be noted that the values of the glass transition temperatures of the acrylic resins, and those of resins A to D (see FIGS. 6 to 8) used in Examples and Comparative Examples described hereinafter are obtained by performing differential thermal analyses, and the values of the weight-average molecular weights of the same are measured by gel permeation chromatography (GPC). Further, the values of the elastic moduli of the acrylic resins and the resins A to D are obtained by measuring the elastic moduli of resin layers of the acrylic resins and the resins A to D by a nanoindentation method. Each resin layer for the measurement is formed by applying each resin on a support for the measurement, not shown, such that the resin layer has a thickness of 1 μm, and subjecting the resin layer to a baking process at 90° C. for 90 seconds, for example.

Then, the prepared mixed resin material is applied to the preform 10 e.g., by the spin coating method, whereby a coating film having a thickness of e.g., 100 nm is formed on the recording layer 14 of the preform 10. Next, the baking process is carried out on the coating film at 90° C. for 90 seconds. Thus, as shown in FIG. 3, the resin layer 3 is formed on the recording layer 14 of the preform 10. Then, the preform 10 is set in an imprinting device with a surface formed with the resin layer 3 facing upward, while the stamper 2 is set in the imprinting device with a surface formed with the concave/convex pattern 25 facing downward. Then, the stamper 2 is moved downward toward the preform 10, whereby the concave/convex pattern 25 is pressed against the surface of the resin layer 3. At this time, in a state in which room temperature (e.g., 22° C.) is maintained, a pressing force of 16.3 MPa, for example, is applied to the whole area of the stamper 2 without heating either the preform 10 (resin layer 3) or the stamper 2 (start of the imprinting process).

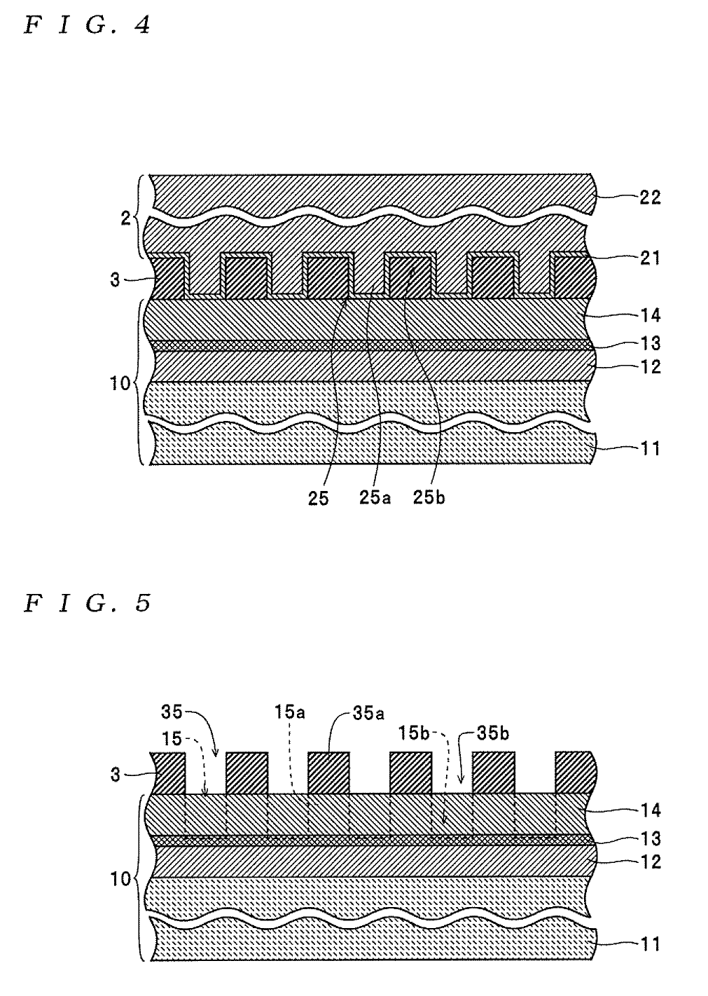

In this case, in the concave/convex pattern forming method, the resin layer 3 is formed by coating the preform 10 with a mixed resin material which contains an acrylic resin having a glass transition temperature lower than the temperature of the resin layer 3 (a resin material having a low elastic modulus and a high fluidity) during pressing of the stamper 2 against the resin layer 3. Therefore, when the stamper 2 is pressed against the resin layer 3, each convex portion 25a of the concave/convex pattern 25 on the stamper 2 is smoothly (easily) pushed into the resin layer 3 although neither the resin layer 3 nor the stamper 2 is heated (although the resin layer 3 has a temperature equal to the room temperature of 22° C.). As a result, as shown in FIG. 4, the convex portion 25a of the stamper 2 is pushed deep enough into the resin layer 3. It should be noted that in FIG. 4 and FIG. 5 referred to hereinafter, for ease of understanding of the present invention, illustration of a resin material (residual layer), which is produced between the surface of a protruding end of each convex portion 25a and the preform 10 (recording layer 14) when the stamper 2 is pressed, is omitted. Subsequently, after the state of the stamper 2 being pressed against the resin layer 3 is maintained e.g., for five minutes, the stamper 2 is moved upward from the preform 10 to thereby remove the stamper 2 from the resin layer 3. This causes, as shown in FIG. 5, the concave/convex shape of the concave/convex pattern 25 of the stamper 2 to be transferred to the resin layer 3, whereby the concave/convex pattern 35 is formed on the preform 10. In this case, the concave/convex pattern 35 formed on the preform 10 has concave portions 35b formed in association with the respective convex portions 25a of the concave/convex pattern 25 of the stamper 2, and convex portions 35a formed in association with the respective concave portions 25b of the concave/convex pattern 25. This completes the process for forming the concave/convex pattern 35 (mask pattern) by the concave/convex pattern forming method according to the present invention.

Then, the residual layer, not shown, remaining on the bottom surface of each concave portion 35b of the concave/convex pattern 35 formed on the resin layer 3 of the preform 10 is removed e.g., by an oxygen plasma treatment. Subsequently, an etching process is performed on (the recording layer 14 of) the preform 10, using the concave/convex pattern 35 (the convex portions 35a thereof) as a mask pattern, whereby the concave/convex pattern 15 is formed on the intermediate layer 13. In this case, in the above described concave/convex pattern forming method, the resin layer 3 is formed by coating the preform 10 with a mixed resin material which contains an acrylic resin having a glass transition temperature higher than the temperature of the resin layer 3 (a resin material having a high elastic modulus and a low fluidity) during pressing of the stamper 2 against the resin layer 3. Therefore, the concave/convex shape of the concave/convex pattern 35 are prevented from being largely deformed before the start of the etching process on the preform 10 after removal of the stamper 3 from the resin layer 3 having the concave/convex pattern 35 formed thereon. As a result, as indicated by broken lines in FIG. 5, the convex portions 15a are formed in association with the respective convex portions 35a of the concave/convex pattern 35 in the state of its concave/convex shape being maintained, and the concave portions 15b are formed in association with the respective concave portions 35b of the concave/convex pattern 35, whereby the concave/convex pattern 15 is formed on the intermediate layer 13, as shown in FIG. 1. This completes the information recording medium manufacturing method according to the present invention to complete the magnetic disk 1.

Next, the relationship between the easiness of pushing the respective convex portions of the stamper into the resin layer on the substrate, the stability of the concave/convex shape of the concave/convex pattern after removal of the stamper therefrom (difficulty of deformation of the concave/convex pattern), and resin materials used for forming the resin layer will be described with reference to drawings.

Mixed resin materials were prepared by combining four kinds of resin materials (e.g., copolymers of acrylic acid ester and methacrylic acid ester: acrylic resins) having different glass transition temperatures, and resin layers of Examples 1 to 4 and Comparative Examples 1 and 2 shown in FIG. 6 were formed on support substrates, not shown. Further, a concave/convex pattern is formed on the support substrate (in the resin layer formed thereon) by pressing the concave/convex pattern 25 of the stamper 2 against the resin layer of each of Examples and Comparative Examples. It should be noted that each resin layer was formed according to the same procedure as employed in the above described method of forming the resin layer 3 except for the method of preparing the mixed resin material. Further, the process for pressing the stamper 2 against each resin layer (concave/convex pattern forming process: imprinting process) was carried out according to the same procedure as employed in the above described process for pressing the stamper 2 against the resin layer 3 (process for forming the concave/convex pattern 35). The concave/convex shapes of surfaces of the resin layers of Examples and Comparative Examples, having the concave/convex pattern formed thereon as described above, were observed by an atomic force microscope (AFM) to thereby confirm the easiness of pushing the convex portions 25a of the stamper 2 into each resin layer, and the stability of the concave/convex shape after removal of the stamper 2 from the resin layer. The results of the confirmations are shown in FIG. 6.

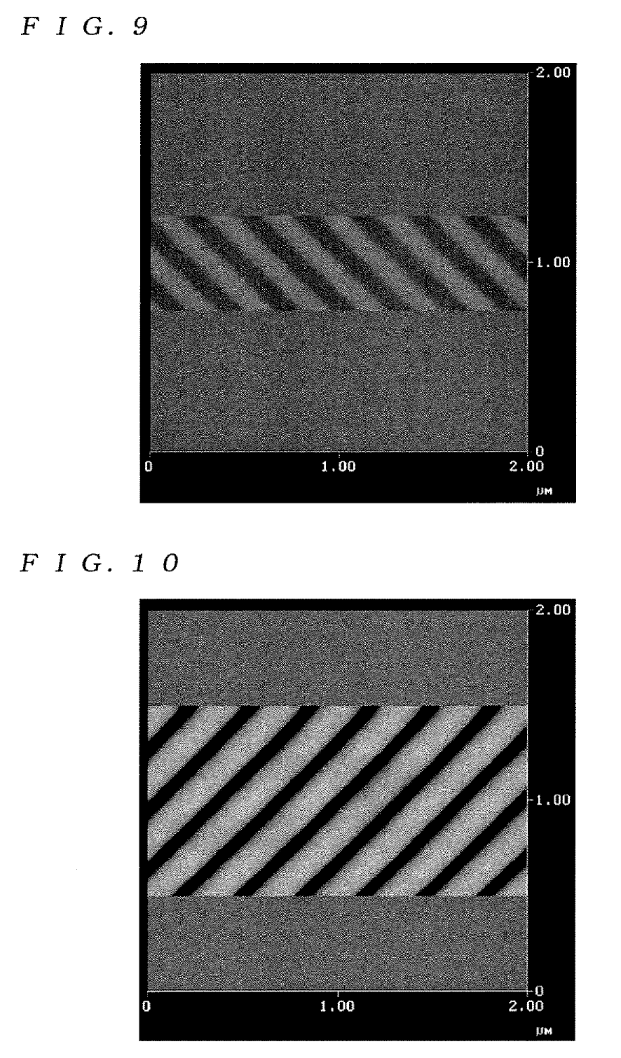

It should be noted that in FIG. 6 and FIGS. 7 and 8 referred to hereinafter, when faulty transfer of the concave/convex pattern was caused, as shown in FIG. 9, due to an insufficient pushing amount of the convex portions 25a into the resin layer, the symbol “X” was entered in the corresponding box under the column of “EASINESS OF PUSHING”; when the concave/convex pattern could be transferred with sufficiently high accuracy although it was difficult to push the convex portions 25a into the resin layer, the symbol “Δ” was entered in the corresponding box under the column of “EASINESS OF PUSHING”; when no faulty transfer of the concave/convex pattern occurred although it was slightly difficult to push the convex portions 25a into the resin layer, the symbol “◯” was entered in the corresponding box under the column of “EASINESS OF PUSHING”; and when the convex portions 25a could easily be pushed deep enough into the resin layer, as shown in FIG. 10, the symbol “⊚” was entered in the corresponding box under the column of “EASINESS OF PUSHING”. In this case, FIGS. 9 and 10, and FIGS. 11 to 14 referred to hereinafter show figure-substitute photographs in which images of the surfaces of the resin layers of Examples and Comparative Examples, having the concave/convex pattern formed thereon, were taken by the AFM. In these figures, a portion of each photograph closer to the surface of each resin layer appears whiter and a portion thereof farther from the surface of the resin layer in the direction of thickness of the resin layer (a deeper portion) appears blacker. This means that a portion where a boundary between a black portion and a white portion is distinct is a portion having less faulty transfer or deformation of a concave/convex pattern formed on each resin layer.

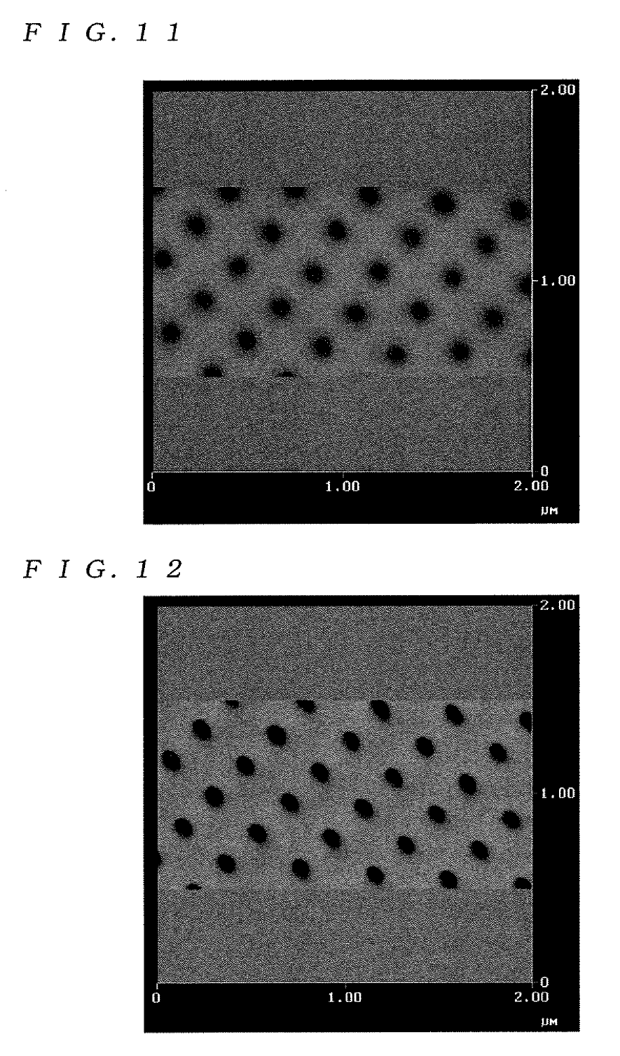

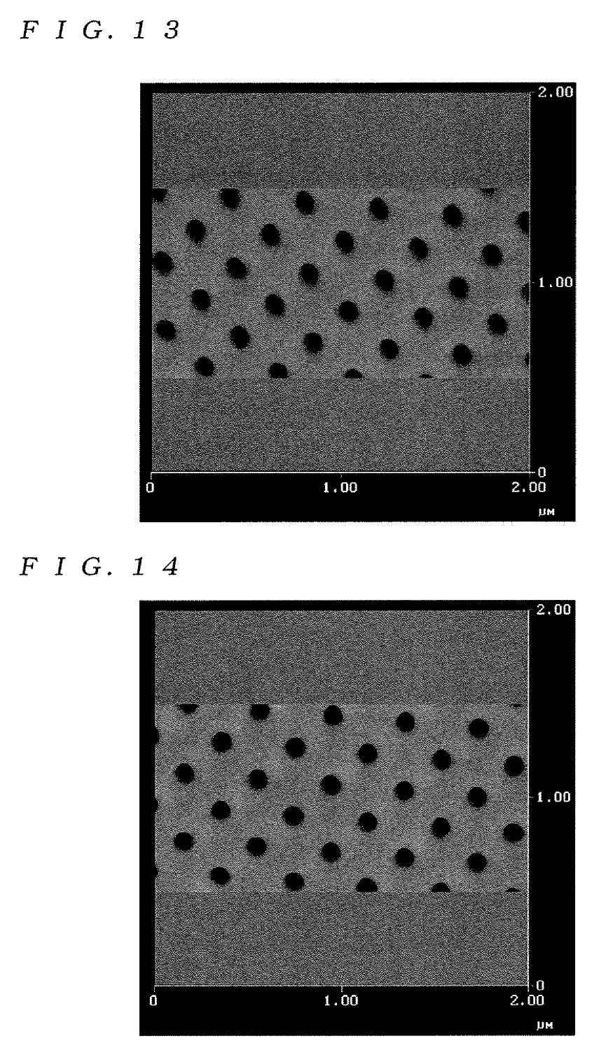

Further, in FIGS. 6 to 8, when the concave/convex pattern formed on each resin layer was largely deformed, as shown in FIG. 11, after the stamper 2 was removed from the resin layer, the symbol “X” was entered in the corresponding box under the column of “STABILITY OF CONCAVE/CONVEX SHAPE”; when the concave/convex pattern formed on each resin layer could be used as a mask pattern although it was slightly deformed as shown in FIG. 12, the symbol “Δ” was entered in the corresponding box under the column of “STABILITY OF CONCAVE/CONVEX SHAPE”; when the concave/convex pattern formed on each resin layer could be used sufficiently as a mask pattern although it was very slightly deformed as shown in FIG. 13, the symbol “◯” was entered in the corresponding box under the column of “STABILITY OF CONCAVE/CONVEX SHAPE”; and when the concave/convex pattern formed on each resin layer was hardly deformed as shown in FIG. 14, the symbol “⊚” was entered in the corresponding box under the column of “STABILITY OF CONCAVE/CONVEX SHAPE”.

### EXAMPLE 1

A resin layer (resin layer in which the concave/convex pattern was to be formed by the imprinting process) was formed using a mixed resin material which was prepared by mixing an acrylic resin (“Resin A” in FIG. 6: hereinafter, this acrylic resin is also referred to as “Resin A”) having a glass transition temperature of 13° C., a weight-average molecular weight of 5782, and an elastic modulus of 1.59 GPa, and an acrylic resin (“Resin C” in FIG. 6: hereinafter, this acrylic resin is also referred to as “Resin C”) having a glass transition temperature of 34° C., a weight-average molecular weight of 5074, and an elastic modulus of 2.98 GPa such that the mixing ratio (volume ratio) thereof became equal to 1:1 (50%:50%).

### EXAMPLE 2

A resin layer was formed using a mixed resin material which was prepared by mixing Resin A and an acrylic resin (“Resin D” in FIG. 6: hereinafter, this acrylic resin is also referred to as “Resin D”) having a glass transition temperature of 27° C., a weight-average molecular weight of 7420, and an elastic modulus of 1.88 GPa such that the mixing ratio (volume ratio) thereof became equal to 1:1 (50%:50%).

### EXAMPLE 3

A resin layer was formed using a mixed resin material which was prepared by mixing an acrylic resin (“Resin B” in FIG. 6: hereinafter, this acrylic resin is also referred to as “Resin B”) having a glass transition temperature of 10° C., a weight-average molecular weight of 5120, and an elastic modulus of 1.46 GPa, and Resin C such that the mixing ratio (volume ratio) thereof became equal to 1:1 (50%:50%).

### EXAMPLE 4

A resin layer was formed using a mixed resin material which was prepared by mixing Resin B and Resin D such that the mixing ratio (volume ratio) thereof became equal to 1:1 (50%:50%).

### COMPARATIVE EXAMPLE 1

A resin layer was formed using a mixed resin material which was prepared by mixing Resin A and Resin B such that the mixing ratio (volume ratio) thereof became equal to 1:1 (50%:50%).

### COMPARATIVE EXAMPLE 2

A resin layer was formed using a mixed resin material which was prepared by mixing Resin C and Resin D such that the mixing ratio (volume ratio) thereof became equal to 1:1 (50% 50%).

Referring to FIG. 6, in the resin layers of Example 1 to Example 4, which were formed using the mixed resin materials each prepared by mixing Resin A or Resin B having a glass transition temperature lower than the temperature (22° C. in the illustrated example) of the resin layer during the imprinting process, and Resin C or Resin D having a glass transition temperature higher than the temperature of the resin layer during the imprinting process, it was possible to push the convex portions 25a deep enough into the resin layer smoothly (easily). Therefore, faulty transfer of the concave/convex pattern was prevented from occurring in these resin layers, and the concave/convex pattern was formed therein with high accuracy. Further, in the resin layers of Examples 1 to 4, the formed concave/convex patterns were not largely deformed even after removal of the stamper 2, and the concave/convex shapes of the concave/convex patterns were maintained accurate enough even when 120 minutes elapsed after the removal of the stamper 2. In contrast, in the resin layer of Comparative Example 1, which was formed using the mixed resin material prepared by mixing the resin materials (Resins A and B) each having a glass transition temperature lower than the temperature of the resin layer during the imprinting process, although it was possible to push the convex portions 25a into the resin layer smoothly (easily) when the stamper 2 was pressed against the resin layer, similarly to the resin layers of Examples 1 to 4, the formed concave/convex pattern was largely deformed after removal of the stamper 2, that is, it was impossible to maintain the concave/convex shape thereof.

On the other hand, in the resin layer of Comparative Example 2, which was formed using the mixed resin material prepared by mixing the resin materials (Resins C and D) each having a glass transition temperature higher than the temperature of the resin layer during the imprinting process, although the formed concave/convex pattern was not largely deformed and the concave/convex shape thereof was maintained after removal of the stamper 2, it was impossible to push the convex portions 25a deep enough into the resin layer when the stamper 2 was pressed against the resin layer, which makes it impossible to form concave portions having a sufficient depth (occurrence of faulty transfer). As described above, in making a resin layer to be formed with a concave/convex pattern by the imprinting process, the use of a mixed resin material prepared by mixing a resin material (Resin A or B in the illustrated example) having a glass transition temperature lower than the temperature of the resin layer during the imprinting process and a resin material (Resin C or D in the illustrated example) having a glass transition temperature higher than the temperature of the resin layer during the imprinting process makes it possible to push the convex portions 25a deep enough into the resin layer when the stamper 2 is pressed against the resin layer, and at the same time form a desired concave/convex pattern with high accuracy (it is possible to avoid the occurrence of faulty transfer of a concave/convex pattern). Further, it is possible to maintain the concave/convex shape of the concave/convex pattern for a long time period after removal of the stamper 2 (avoid deformation of the concave/convex pattern).

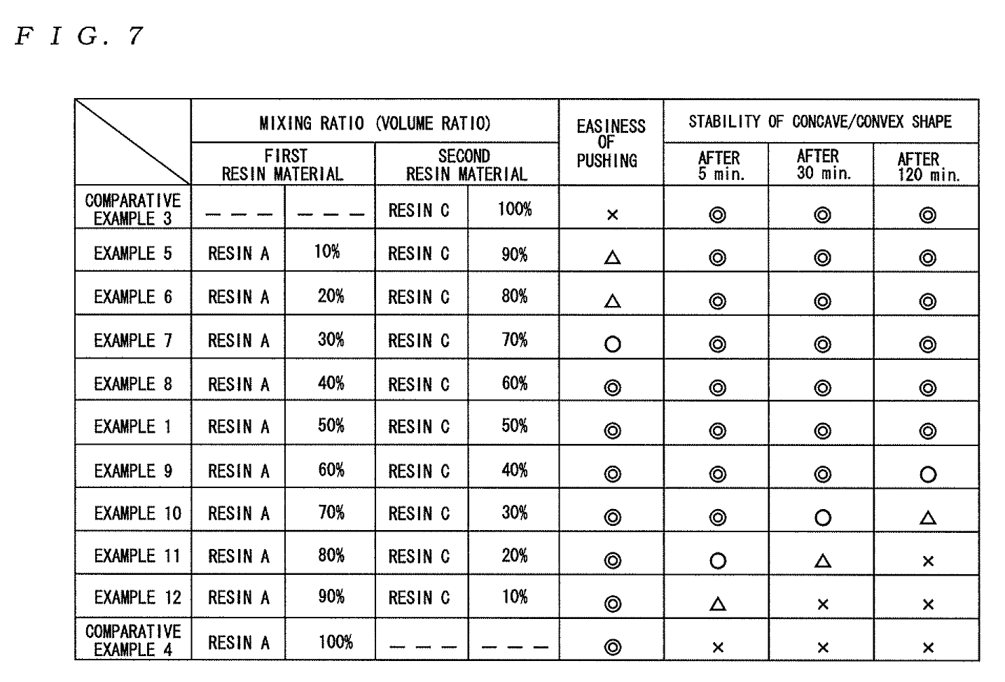

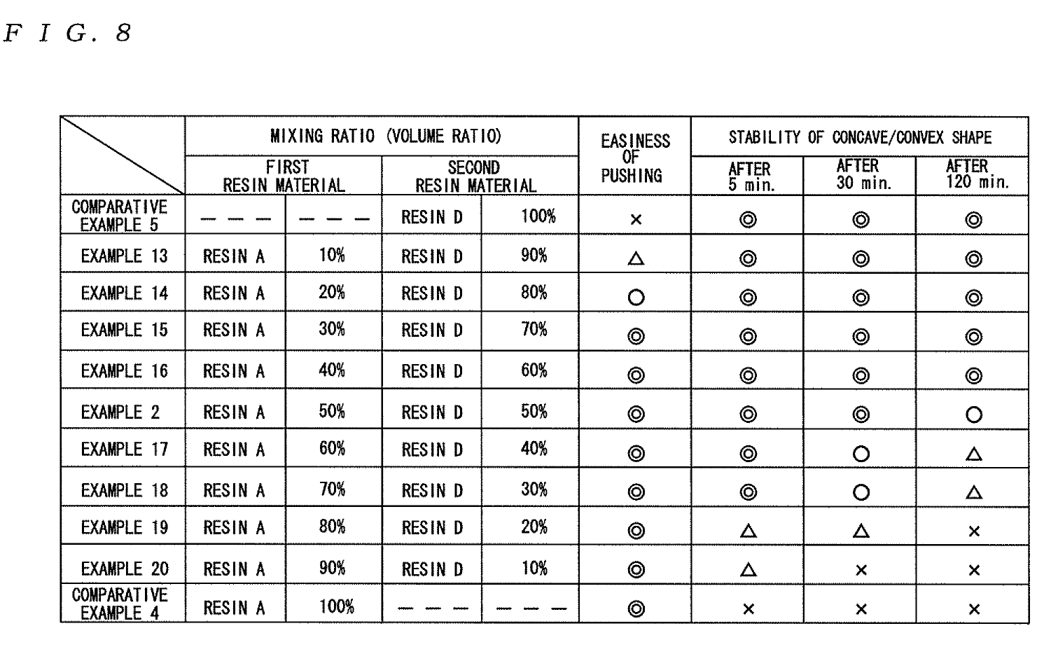

Then, after mixed resin materials were prepared by changing the mixing ratio (volume ratios) of resin materials, resin layers of Examples 5 to 20 and Comparative Examples 3 to 5 were formed on support substrates, and concave/convex patterns were formed on the resin layers, so as to check the easiness of pushing the convex portions 25a of the stamper 2 into each resin layer, and the stability of the concave/convex shape after removal of the stamper 2 from the resin layer. The results of the check are shown in FIGS. 7 and 8. It should be noted that the resin layers of Examples and Comparative Examples were formed according to the same procedure as employed in the aforementioned method of forming the resin layer 3 except for the method of preparing a mixed resin material. Further, the process for pressing the stamper 2 against each resin layer (concave/convex pattern forming process: imprinting process) was carried out according to the same procedure as employed in the aforementioned process for pressing the stamper 2 against the resin layer 3 (process for forming the concave/convex pattern 35).

### EXAMPLE 5

A resin layer was formed using a mixed resin material which was prepared by mixing Resin A and Resin C such that the mixing ratio (volume ratio) thereof became equal to 1:9 (10%:90%).

### EXAMPLE 6

A resin layer was formed using a mixed resin material which was prepared by mixing Resin A and Resin C such that the mixing ratio (volume ratio) thereof became equal to 2:8 (20%:80%).

### EXAMPLE 7

A resin layer was formed using a mixed resin material which was prepared by mixing Resin A and Resin C such that the mixing ratio (volume ratio) thereof became equal to 3:7 (30%:70%).

### EXAMPLE 8

A resin layer was formed using a mixed resin material which was prepared by mixing Resin A and Resin C such that the mixing ratio (volume ratio) thereof became equal to 4:6 (40%:60%).

### EXAMPLE 9

A resin layer was formed using a mixed resin material which was prepared by mixing Resin A and Resin C such that the mixing ratio (volume ratio) thereof became equal to 6:4 (60%:40%)

### EXAMPLE 10

A resin layer was formed using a mixed resin material which was prepared by mixing Resin A and Resin C such that the mixing ratio (volume ratio) thereof became equal to 7:3 (70%:30%).

### EXAMPLE 11

A resin layer was formed using a mixed resin material which was prepared by mixing Resin A and Resin C such that the mixing ratio (volume ratio) thereof became equal to 8:2 (80%:20%).

### EXAMPLE 12

A resin layer was formed using a mixed resin material which was prepared by mixing Resin A and Resin C such that the mixing ratio (volume ratio) thereof became equal to 9:1 (90%:10%).

### EXAMPLE 13

A resin layer was formed using a mixed resin material which was prepared by mixing Resin A and Resin D such that the mixing ratio (volume ratio) thereof became equal to 1:9 (10%:90%).

### EXAMPLE 14

A resin layer was formed using a mixed resin material which was prepared by mixing Resin A and Resin D such that the mixing ratio (volume ratio) thereof became equal to 2:8 (20%:80%).

### EXAMPLE 15

A resin layer was formed using a mixed resin material which was prepared by mixing Resin A and Resin D such that the mixing ratio (volume ratio) thereof became equal to 3:7 (30% 70%).

### EXAMPLE 16

A resin layer was formed using a mixed resin material which was prepared by mixing Resin A and Resin D such that the mixing ratio (volume ratio) thereof became equal to 4:6 (40%:60%).

### EXAMPLE 17

A resin layer was formed using a mixed resin material which was prepared by mixing Resin A and Resin D such that the mixing ratio (volume ratio) thereof became equal to 6:4 (60%:40%).

### EXAMPLE 18

A resin layer was formed using a mixed resin material which was prepared by mixing Resin A and Resin D such that the mixing ratio (volume ratio) thereof became equal to 7:3 (70%:30%).

### EXAMPLE 19

A resin layer was formed using a mixed resin material which was prepared by mixing Resin A and Resin D such that the mixing ratio (volume ratio) thereof became equal to 8:2 (80%:20%).

### EXAMPLE 20

A resin layer was formed using a mixed resin material which was prepared by mixing Resin A and Resin D such that the mixing ratio (volume ratio) thereof became equal to 9:1 (90%:10%).

### COMPARATIVE EXAMPLE 3

A resin layer was formed using Resin C alone.

### COMPARATIVE EXAMPLE 4

A resin layer was formed using Resin A alone.

### COMPARATIVE EXAMPLE 5

A resin layer was formed using Resin D alone.

Referring to FIG. 7 and 8, in the resin layers of Examples 1, 2, and 5 to 20, which were formed using mixed resin materials each containing not smaller than 10% of the resin A having a glass transition temperature lower than the temperature (22° C. in the illustrated example) of the resin layer during the imprinting process, and the resin layer of Comparative Example 4, which was formed using the resin A alone, when the stamper 2 was pressed against each resin layer, it was possible to push the convex portions 25a of the stamper 2 deep enough into the resin layer smoothly (easily). In contrast, in the resin layers of Comparative Example 3 and Comparative Example 5, which were formed using the resin C alone or the resin D alone, respectively, without containing the resin A having a glass transition temperature lower than the temperature of the resin layer during the imprinting process, when the stamper 2 was pressed against each resin layer, it was impossible to push the convex portions 25a of the stamper 2 deep enough into the resin layer to form concave portions having a sufficient depth (occurrence of faulty transfer). From the above, it can be understood that if a resin layer to be formed with a concave/convex pattern is formed using a mixed resin material which contains at least 10% of a resin material (Resin A in the illustrated example) having a glass transition temperature lower than the temperature of the resin layer during the imprinting process, it is possible to push the convex portions 25a deep enough into the resin layer smoothly when the stamper 2 is pressed against the resin layer, and at the same time form a desired concave/convex pattern with high accuracy (it is possible to avoid occurrence of faulty transfer of the concave/convex pattern).

On the other hand, in the resin layers of Examples 1, 2, and 5 to 20, which were formed using mixed resin materials each containing not smaller than 10% of a resin material (resin C or D) having a glass transition temperature higher than the temperature of the resin layer during the imprinting process, the resin layer of Comparative Example 3, which was formed using the resin C alone, and the resin layer of Comparative Example 5, which was formed using the resin D alone, no concave/convex patterns formed on the respective layers were largely deformed, and the concave/convex shapes of the concave/convex patterns were maintained with high accuracy, even after removal of the stamper 2. In contrast, in the resin layer of Comparative Example 4, which was formed using the resin A alone without containing a resin material (resin C or D) having a glass transition temperature higher the temperature of the resin layer during the imprinting process, the formed concave/convex pattern was largely deformed after removal of the stamper 2, which made it impossible to maintain the concave/convex shape of the concave/convex pattern. From the above, it can be understood that if a resin layer to be formed with a concave/convex pattern is formed using a mixed resin material which contains at least 10% of a resin material (Resin C or D in the illustrated example) having a glass transition temperature higher than the temperature of the resin layer during the imprinting process, it is possible to prevent the formed concave/convex pattern from being largely deformed after removal of the stamper 2, to maintain the concave/convex shape of the pattern with high accuracy.

In this case, as shown in FIGS. 7 and 8, to form a concave/convex pattern with sufficiently high accuracy while preventing the occurrence of faulty transfer of the concave/convex pattern, it is preferable to form a resin layer to be formed with the concave/convex pattern, by using a mixed resin material containing not smaller than 30% of a resin material (resin A) having a glass transition temperature lower than the temperature of the resin layer during the imprinting process. Further, to maintain the concave/convex shape of the concave/convex pattern for a sufficiently long time period by preventing deformation of the concave/convex pattern after removal of the stamper 2, it is preferable to form a resin layer to be formed with the concave/convex pattern, by using a mixed resin material containing not smaller than 30% of a resin material (resin C or D) having a glass transition temperature higher than the temperature of the resin layer during the imprinting process. Therefore, to form a concave/convex pattern with sufficiently high accuracy while preventing the occurrence of faulty transfer of the concave/convex pattern, and maintain the concave/convex shape of the concave/convex pattern for a sufficiently long time period by preventing deformation of the concave/convex pattern after removal of the stamper 2, it is preferable to prepare a mixed resin material which contains not smaller than 30% of a resin material having a glass transition temperature lower than the temperature of the resin layer during the imprinting process, and contains not smaller than 30% of a resin material having a glass transition temperature higher than the temperature of the resin layer during the imprinting process.

As described hereinbefore, according to the aforementioned concave/convex pattern forming method, the resin layer 3 is formed by coating the preform 10 (substrate) with a mixed resin material which is prepared by mixing the first resin material having a glass transition temperature lower than the temperature of the resin layer 3 during pressing of the stamper 2 against the resin layer 3, and the second resin material having a glass transition temperature higher than the temperature of the resin layer 3 during pressing of the stamper 2 against the resin layer 3, which makes it possible to push the convex portions 25a of the concave/convex pattern 25 deep enough into the resin layer 3 smoothly when the stamper 2 is pressed against the resin layer 3. Therefore, it is possible to form the concave/convex pattern 35 on the preform 10 with high accuracy while preventing the occurrence of faulty transfer of the concave/convex pattern 25 due to insufficient pushing amount of the convex portions 25a. Further, it is possible to maintain the concave/convex shape of the concave/convex pattern 35 with high accuracy while preventing large deformation of the concave/convex pattern 35, after removal of the stamper 2 from the resin layer 3.

Further, according to the aforementioned information recording medium manufacturing method, the magnetic disk 1 (information recording medium) is manufactured using the concave/convex pattern 35 formed on the preform 10 (substrate) according to the above described concave/convex pattern forming method, which makes it possible to form the concave/convex pattern 15 with high accuracy over the whole area of the preform 10, by subjecting the preform 10 to an etching process e.g., using the formed concave/convex pattern 35 as a mask pattern, or a concave/convex pattern matching the concave/convex pattern 35 in the concave-convex positional relationship as a mask pattern.

It should be noted that the present invention is by no means limited to the above described configurations and methods. For example, although in the above described concave/convex pattern forming method, the imprinting process is carried out without heating or cooling the preform 10, the resin layer 3, and the stamper 2, this is not limitative, but to further facilitate pushing of the convex portions 25a into the resin layer 3, it is also possible to employ a method of heating the preform 10, the resin layer 3, and the stamper 2 to a certain degree of temperature prior to the start of the imprinting process. In this method as well, by causing a resin material having a glass transition temperature higher than the temperature of the resin layer 3 during the imprinting process to be contained in a resin material used for forming the resin layer 3, it is possible to sufficiently prevent large deformation of the concave/convex pattern 35 formed on the resin layer 3, even if the preform 10, the resin layer 3, and the stamper 2 are not cooled before removal of the stamper 2.

Further, for example, when the temperature of a work place where the imprinting process is performed is high, to prevent deformation of the concave/convex pattern 35 after removal of the stamper 2, it is also possible to employ a method of cooling the preform 10, the resin layer 3, and the stamper 2 to a certain degree of temperature prior to the start of the imprinting process. In this method as well, by causing a resin material having a glass transition temperature lower than the temperature of the resin layer 3 during the imprinting process to be contained in a resin material used for forming the resin layer 3, it is possible to easily push the convex portions 25a of the stamper 2 into the resin layer 3 even if the temperature of the resin layer 3 is lowered by the cooling process. This makes it possible to sufficiently prevent the occurrence of faulty transfer of the concave/convex pattern.

What is claimed is:

1. A concave/convex pattern forming method comprising pressing a stamper having a stamper-side concave/convex pattern formed thereon against a resin layer on a substrate, thereby transferring the stamper-side concave/convex pattern to the resin layer to form a concave/convex pattern on the substrate,
wherein the resin layer is formed by coating the substrate with a mixed resin material which is prepared by mixing a first resin material having a glass transition temperature lower than a temperature of the resin layer during pressing of the stamper against the resin layer, and a second resin material having a glass transition temperature higher than the temperature of the resin layer during the pressing of the stamper against the resin layer.

2. An information recording medium manufacturing method comprising using the concave/convex pattern formed on the substrate according to the concave/convex pattern forming method according to claim 1 to manufacture an information recording medium.
